(19) United States
(12) Patent Application Publication
(10) Pub. No.: US 2009/0248263 A1
(43) Pub. Date: Oct. 1, 2009

(54) SHIFT CONTROL APPARATUS FOR AUTOMATIC TRANSMISSION

(75) Inventor: Takayuki KUBO, Anjo-shi (JP)

Correspondence Address: BACON & THOMAS, PLLC, 625 SLATERS LANE, FOURTH FLOOR, ALEXANDRIA, VA, 22314-1176, US

(73) Assignee: AISIN AW CO., LTD., Anjo-shi (JP)

(21) Appl. No.: 12/397,730

(22) Filed: Mar. 4, 2009

(30) Foreign Application Priority Data
Mar. 28, 2008 (JP) 2008-085342

(51) Int. Cl. G06F 19/00

(52) U.S. Cl. 701/55

(57) ABSTRACT

Strain gauges and a torque value calculating unit detect a value for torque acting on a sun gear based on a reaction force, an input equivalent value calculating unit calculates an input torque equivalent value based on the torque value detected, a torque reduction command unit issues a command to the engine for changing torque, and a torque change determination unit determines, based on the input torque equivalent value calculated, whether or not the torque of the engine has been appropriately changed in accordance with the command. Consequently, based on the torque value measured for the sun gear that is a component of the automatic speed change mechanism, it can be precisely determined whether or not the torque change for the engine has been appropriately achieved as targeted.

### INCORPORATION BY REFERENCE

The disclosure of Japanese Patent Application No. 2008-085342 filed on Mar. 28, 2008, including the specification, drawings and abstract is incorporated herein by reference in its entirety.

### BACKGROUND OF THE INVENTION

1. Field of the Invention

The present invention relates to a shift control apparatus for an automatic transmission mounted on a vehicle such as an automobile, and particularly to a shift control apparatus for an automatic transmission that is capable of precisely determining whether or not a torque change that has been applied to a driving source such as an engine is that targeted.

2. Description of the Related Art

Automatic transmissions in general, particularly stepped automatic transmissions, shift by switching engagement among friction engagement elements (clutches and/or brakes), with hydraulic shift control, using linear solenoid valves and so forth. Hydraulic pressures are supplied to hydraulic servos for the friction engagement elements, based on hydraulic pressure command values calculated corresponding to rotational speed of an input shaft and engine output.

Such shift control apparatuses for an automatic transmission include apparatuses that compensate for product deviations and temporal changes in the automatic transmission by learning control, using learning values (correction values) for correcting the hydraulic pressure command values, which learning values are calculated based on the previous shifting state, recorded and then reflected in the hydraulic pressure command values for the next shift control (refer, for example, to Japanese Patent Application Publication No. JP-A-2004-293593).

### SUMMARY OF THE INVENTION

In some of the automatic transmissions that perform learning control as described above, determination is made using only the level of rotational acceleration change and time for shifting in feedback control (FB control) that feeds back engine rotational speed during shifting and in the learning control for engagement pressure supplied to the friction engagement elements such as clutches and brakes. However, in actual shifting, the level of rotational speed acceleration and the time for shifting are determined not only by the engagement pressures to engage the friction engagement elements such as clutches and brakes, but also by the engine output at that moment.

In torque reduction (spark retard) during shifting, if the amount of torque reduction happens to be large, the rotational speed acceleration is increased to a large extent and the shifting time is shortened. Then, even with good shift shock reduction by torque reduction, the hydraulic pressure is increased by the FB control and the learning correction reduces the engagement pressure in the next shift control cycle, because the rotational speed acceleration is relatively large.

The rotational speed acceleration is determined by an engagement torque and the torque reduction on the engine side. However, because the inertia phase serving as a trigger to start the torque reduction is detected as an occurrence of the rotational speed change, accurate detection is difficult. Therefore, it is essential to detect the inertia phase as accurately as possible to precisely set the start timing of the torque reduction in order to obtain better learning control for reducing shift shock in the next shift control cycle.

Therefore, it is an object of the present invention to provide a shift control apparatus for an automatic transmission that makes it possible to determine, based on a torque value measured for a fixed gear of a speed change mechanism, whether or not a torque change such as a torque reduction has been appropriately achieved as targeted, in order, for example, to skip the next learning correction for engagement pressure if the torque reduction has not been appropriate.

The present invention provides a shift control apparatus for an automatic transmission, wherein the automatic transmission includes: a stepped speed change mechanism that introduces rotation of a driving source to an input shaft and couples an output member to drive wheels, the speed change mechanism including a fixed gear that is fixed to a transmission case and generates a reaction force against the rotation of the input shaft; a plurality of engagement elements for shifting between power transmission paths between the input shaft and the output member; hydraulic servos that disconnect and connect the engagement elements; a shift control unit that performs shifting to a predetermined shift speed by controlling operation of the hydraulic servos so as to engage a first engagement element and disengage a second engagement element; a fixed gear torque detecting unit that detects, based on the reaction force, a value for torque acting on the fixed gear; an input equivalent value calculating unit that calculates an input torque equivalent value based on the detected torque value; a torque change command unit that issues a command to change torque to the driving source; and a torque change determination unit that determines, based on the calculated input torque equivalent value, whether or not the torque of the driving source has been appropriately changed in accordance with the command of the torque change command unit.

Note that, as used herein, “disengagement of an engagement element” is intended to broadly include, not only disengagement of a friction engagement, but also release of a locked state by reversing the direction of rotation of a rotary element, as in the case of a one-way clutch.

Thus, the fixed gear torque detecting unit detects the value for torque acting on the fixed gear based on the reaction force, the input equivalent value calculating unit calculates the input torque equivalent value based on the detected torque value, the torque change command unit issues the command for changing torque to the driving source, and the torque change determination unit determines, based on the calculated input torque equivalent value, whether or not the torque of the driving source has been appropriately changed in accordance with the command of the torque change command unit. Therefore, based on the torque value detected for the fixed gear of the speed change mechanism, it can be determined whether or not the torque change for the driving source has been appropriately achieved as targeted. For example, when the engaging-side hydraulic pressure for the engagement element has been increased and then the engaging side starts to transmit torque, inertia change on the input side enables detection of the torque as an input torque by using the fixed gear torque detecting unit. By using the level of the input torque equivalent value as an indicator for control during shifting, it can be immediately determined whether or not there has been a problem in the amount of the torque change if rotational speed acceleration does not turn out as expected, and if there has not been a problem in the amount of the torque change, it can then be immediately determined that there has been a problem in the engaging-side hydraulic pressure.

According to one aspect of the present invention, the shift control apparatus further includes: a learning control unit that is capable of learning the engagement state of the first engagement element, controlled by the shift control unit. The learning control unit refrains from learning correction if the torque change determination unit determines that the torque of the driving source has not been appropriately changed. In the present invention, it is determined whether or not the torque change has been appropriately achieved as targeted, and if, for example, a torque reduction has been inaccurate because a spark retard has not been effected or has been excessive, the current learning value is not applied in the next shift control cycle.

In a preferred embodiment, the shift control apparatus further includes: an inertia phase detecting unit that detects a start of an inertia phase, based on a change in the torque value detected by the fixed gear torque detecting unit. In this embodiment, the torque change command unit is a torque down command unit that issues a command for performing a torque down as the torque change, responsive to detection of the start of the inertia phase by the inertia phase detecting unit. Therefore, by detecting the change in the value for torque acting on the fixed gear, it becomes possible to detect the start of the inertia phase quickly and accurately, thereby enabling the torque change to be performed at an appropriate timing.

The fixed gear torque detecting unit is composed of: a strain detecting sensor that detects strain between the fixed gear and the transmission case caused by the torque acting from the input shaft side; and a torque value calculating unit calculates the value for torque acting on the fixed gear, based on the strain detected by the strain detecting sensor. Therefore, for example, a strain gauge of a simple structure and comparatively low cost can be used as the strain detecting sensor. Further, because a structure for easily detecting the strain between the fixed gear and the transmission case is obtained by, for example, directly adhering the strain gauge on the fixed gear, it is possible to detect the torque value used for detecting the inertia phase with an extremely simple structure.

According to another aspect of the present invention, the speed change mechanism includes: a decelerating planetary gear set that outputs decelerated rotation, i.e. rotation that is decelerated from the rotational speed of the input shaft; a planetary gear unit that has four rotary elements including an output element connected to an output shaft of the speed change mechanism; two decelerating clutches that, when engaged, transmit rotation of the decelerating planetary gear set, respectively, to two of the rotary elements of the planetary gear unit; and an input clutch that, when engaged, transmits rotation of the input shaft to one of the rotary elements of the planetary gear unit, thereby achieving five or six forward speeds. The fixed gear is a gear that is constantly held stationary (without rotation) in the decelerating planetary gear set. Therefore, by using a comparatively simple structure based on merely a strain detecting sensor or the like that is attached to the fixed gear when assembling the speed change mechanism, the change in the input torque can be directly and accurately detected by, for example, detecting the inertia phase early and accurately, and that detection can be used, for example, to prevent erroneous learning in learning control.

According to another aspect of the present invention, the decelerating planetary gear set includes a sun gear that is fixed to the transmission case, a ring gear that outputs the decelerated rotation, and a carrier that receives the rotation of the input shaft, wherein the fixed gear is the sun gear.

### BRIEF DESCRIPTION OF THE DRAWINGS

FIG. 1 is a block diagram of a shift control apparatus for an automatic transmission according to the present invention;

FIG. 2 is a skeletal diagram of an automatic speed change mechanism to which the present invention can be applied;

FIG. 3 is an engagement table for the automatic speed change mechanism;

FIG. 4 is a velocity diagram for the automatic speed change mechanism;

FIG. 5 is a schematic diagram showing a constantly stationary (non-rotating) sun gear in a planetary gear set in the automatic speed change mechanism, and also showing strain gauges fixed to the sun gear;

FIG. 6 is a diagram of a hydraulic circuit in a hydraulic control device;

FIG. 7 is a flow chart of operation of the shift control apparatus for the automatic transmission; and

FIG. 8 is a time chart for operation of the shift control apparatus for the automatic transmission.

### DESCRIPTION OF THE PREFERRED EMBODIMENTS

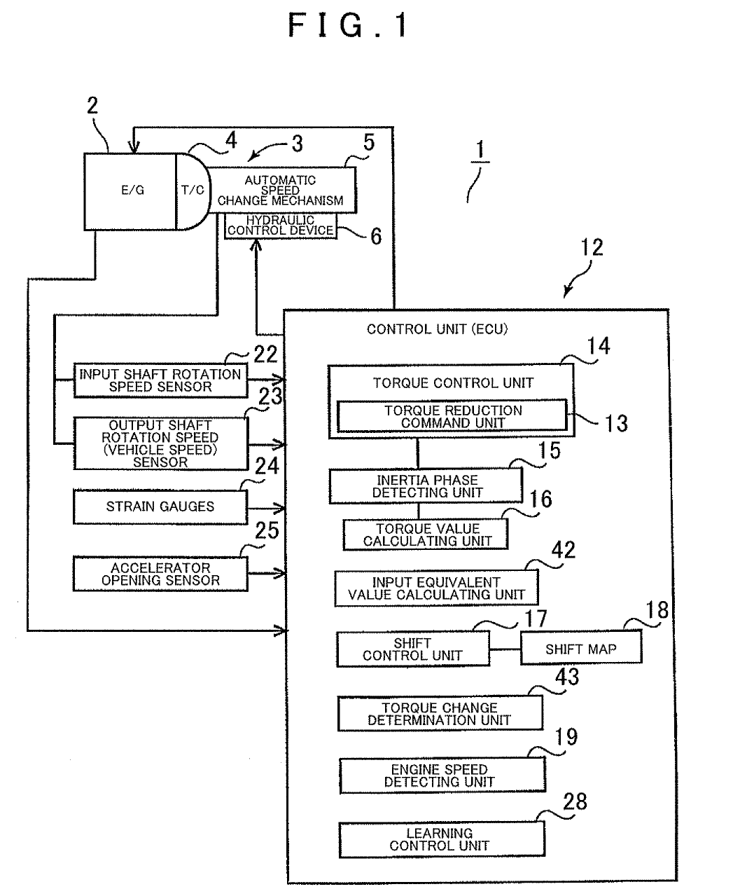

A preferred embodiment of the present invention will now be described below with reference to FIGS. 1 to 8.

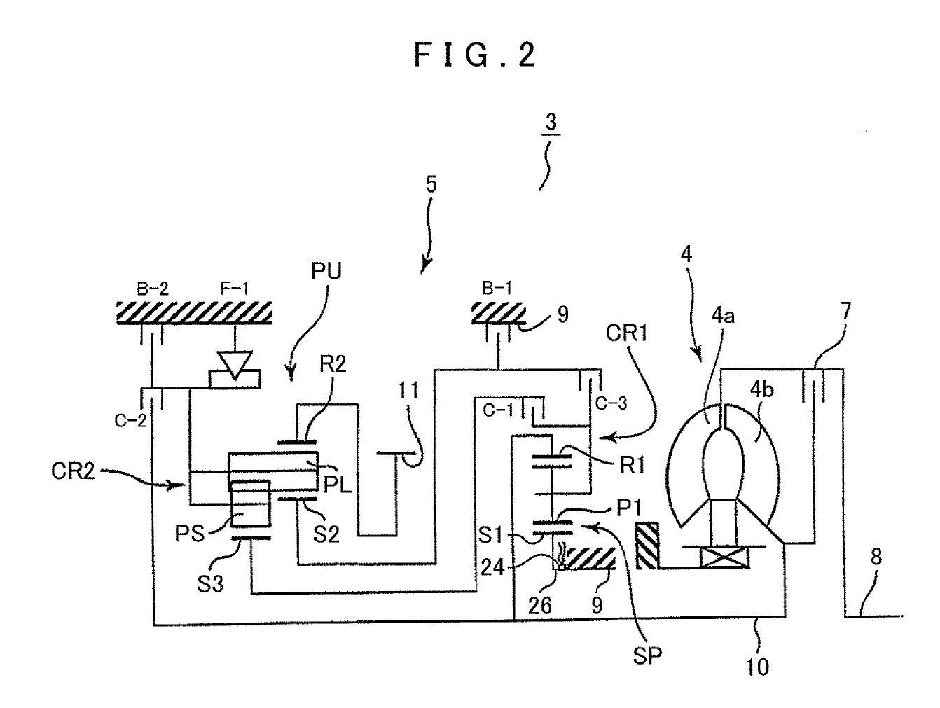

First, the structure of an automatic transmission 3 to which the present invention can be applied will be described with reference to FIG. 2. FIG. 2 shows an automatic transmission 3 that is suitable for use in, for example, an FF (front engine, front drive) type vehicle. The automatic transmission 3 has an input shaft 8 connected to an engine 2 (refer to FIG. 1) serving as a driving source, and is provided with a torque converter 4 and an automatic speed change mechanism 5 with the centers thereof aligned along the axis of the input shaft 8. A reference a transmission case 9 houses the automatic speed change mechanism 5.

The automatic transmission 3 is a stepped automatic transmission that has clutches C-1, C-2, and C-3, and brakes B-1 and B-2 serving as friction engagement elements whose engagement states determine which one of a plurality of power transmission paths is established in the automatic speed change mechanism 5, and that achieves six forward speeds by switching engagement among those engagement elements. The present invention can be applied, not only to an automatic transmission for shifting among six forward speeds, but also to a five speed automatic transmission.

The torque converter 4 has a pump impeller 4a connected to the input shaft 8 of the automatic transmission 3, and a turbine runner 4b to which the rotation of the pump impeller 4a is transmitted through hydraulic fluid. The turbine runner 4b is connected to an input shaft 10 of the automatic speed change mechanism 5 arranged coaxially with the input shaft 8. In addition, the torque converter 4 is provided with a lockup clutch 7, and when the lockup clutch 7 is engaged by the hydraulic control device 6 (refer to FIG. 1), the rotation of the input shaft 8 of the automatic transmission 3 is directly transmitted to the input shaft 10 of the automatic speed change mechanism 5. The hydraulic control device 6 is provided with multiple hydraulic servos (not shown) for operating the automatic speed change mechanism 5, as well as multiple shift valves for switching hydraulic pressure to these hydraulic servos.

The automatic speed change mechanism 5 is provided with a planetary gear set SP and a planetary gear unit PU on the input shaft 10. The planetary gear set SP is a so-called single pinion planetary gear set that is provided with a sun gear (fixed gear) S1, a carrier CR1, and a ring gear R1, the carrier CR1 having a pinion P1 that meshes with the sun gear S1 and the ring gear R1. The sun gear S1 is a gear that is constantly held stationary (without rotation) in the planetary gear set SP. Note that the planetary gear set SP serves as a decelerating planetary gear set that is capable of outputting rotation (“decelerated rotation”) that is decelerated from the speed of rotation of the input shaft 10.

The planetary gear unit PU is a so-called Ravigneaux type planetary gear set that has a sun gear S2, a sun gear S3, a carrier CR2, and a ring gear R2 (four rotary elements), the carrier CR2 having a long pinion PL that meshes with the sun gear S2 and the ring gear R2, and a short pinion PS that meshes with the sun gear S3. The clutches C-3 and C-1 serve as decelerating clutches that transmit rotation of the planetary gear set SP, respectively, to the sun gears S2 and S3 (two of the rotary elements of the planetary gear unit PU). The clutch C-2 serves as an input clutch that, when engaged, transmits rotation of the input shaft 10 to the carrier CR2 (one of the rotary elements of the planetary gear unit PU). The ring gear R2 is an output element connected to an output shaft (not shown) of the automatic speed change mechanism 5.

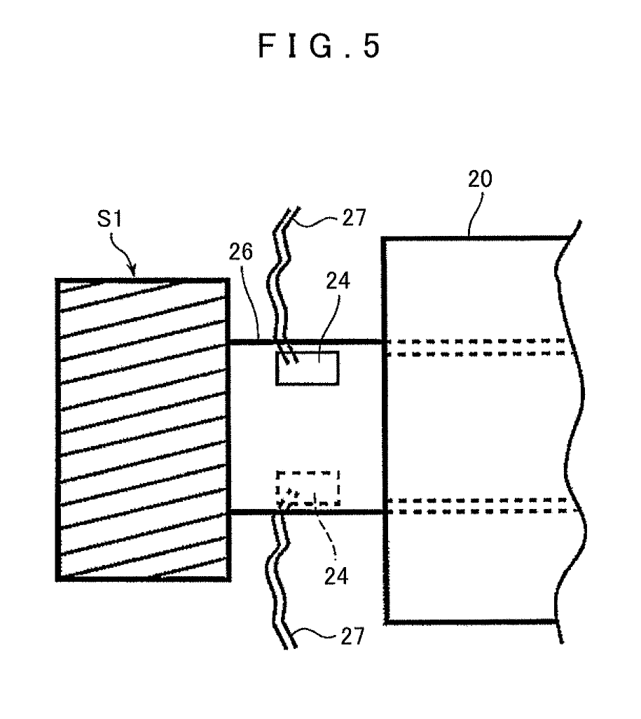

As shown in FIGS. 2 and 5, the sun gear S1 of the planetary gear set SP is fixed to the transmission case 9 to generate a reaction force against the rotation of the input shaft 10; that is, the sun gear S1 is a fixed gear that is connected (through a spline connection) to a boss 20 fixed as a unit to the transmission case 9 and the sun gear S1 is thereby constantly held stationary (without rotation). A shaft portion 26 of the sun gear S1 is connected to the transmission case 9 (that is, the boss 20). A strain gauge 24 that detects strain on the sun gear S1 (that is, the shaft portion 26), corresponding to the torque transmitted to the sun gear S1 from the input shaft 10 side, is directly fixed by adhesive or the like to the sun gear S1. The strain gauge 24 is a strain detecting sensor for detecting the strain between the sun gear S1 and the transmission case 9 caused by the torque acting from the input shaft 10 side.

Strain gauges 24 are fixed to the shaft portion 26 on two opposing sides of the shaft portion 26. Thus, the strain is detected by two strain gauges fixed to the outer circumferential surface of the shaft portion 26. The strain gauges 24 are connected to a control unit 12 through electrical connection cables 27. Note that the number of the strain gauges 24 is not limited to two. It is obvious that the strain gauges 24 may also be fixed to three or four positions on the outer circumferential surface of the shaft portion 26 at even angular intervals.

As shown in FIG. 2, the rotation of the ring gear R1 is the same as the rotation of the input shaft 10 (hereinafter called “input rotation”). Moreover, the rotational speed of carrier CR1 is decelerated from the input rotational speed by the ring gear R1 (rotating at the input rotational speed) in cooperation with the fixed sun gear S1. The carrier CR1 is connected to the clutch C-1 and to the clutch C-3.

The sun gear S2 of the planetary gear unit PU can be fixed to the transmission case 9 by engagement of the brake (engagement element) B-1, and is also connected by engagement of the clutch C-3 to be able to receive the decelerated rotation input from the carrier CR1 through the clutch C-3. In addition, the sun gear S3 is connected by engagement of the clutch C-1 to receive the decelerated rotation input from the carrier CR1. Moreover, the carrier CR2 is connected by engagement of the clutch C-2 to receive the rotation input from the input shaft 10. The carrier CR2 is also restricted to rotation in one direction relative to the transmission case 9 through the one-way clutch F-1 and can be held stationary (without rotation) by engagement of the brake B-2. The ring gear R2 is connected to a counter gear 11, and the counter gear 11 is connected to drive wheels (not shown) through a counter shaft (not shown) and a differential device (not shown).

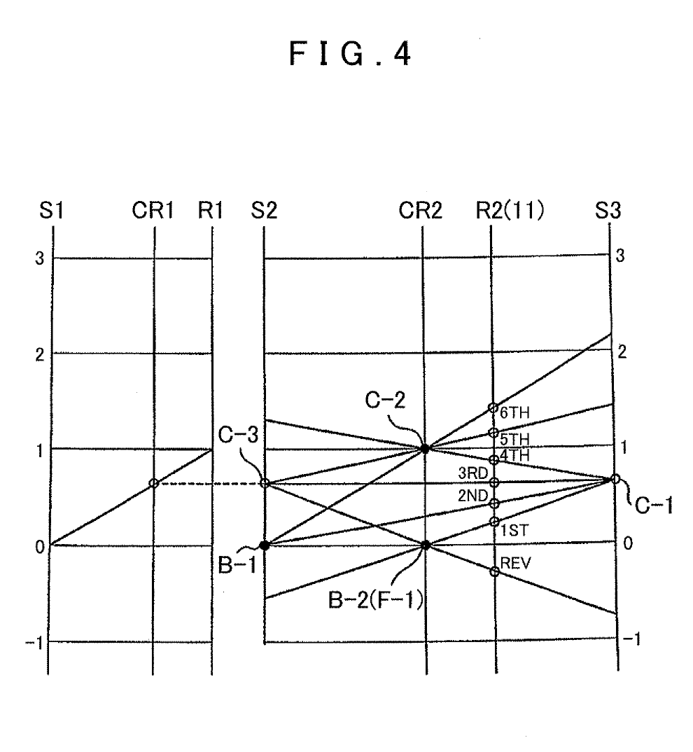

Next, the operation of the above-described automatic speed change mechanism 5 will be described with reference to FIGS. 2, 3, and 4. In the velocity diagram shown in FIG. 4, each vertical axis represents the rotational speed of a rotary element (gear), and the horizontal axis represents the gear ratios of those rotary elements. In addition, in the planetary gear set SP section of the velocity diagram, the vertical axes correspond to the sun gear S1, the carrier CR1, and the ring gear R1, in that order from the left in FIG. 4. Moreover, in the planetary gear unit PU section of the velocity diagram, the vertical axes correspond to the sun gear S3, the ring gear R2, the carrier CR2, and the sun gear S2, in that order from the right in FIG. 4.

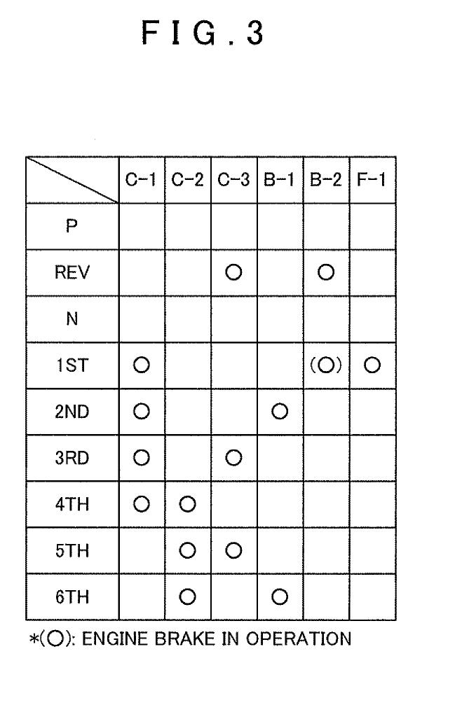

For example, at the first forward speed (1ST) in the D (drive) range, the clutch C-1 and the one-way clutch F-1 are engaged, as shown in FIG. 3. Then, as shown in FIGS. 2 and 4, the rotation of the carrier CR1, which is rotated at a decelerated speed by the ring gear R1 in cooperation with the fixed sun gear S1, is introduced to the sun gear S3 through the clutch C-1. In addition, the rotation of the carrier CR2 is restricted to one direction (forward rotating direction). Then, the decelerated rotation introduced to the sun gear S3 is output to the ring gear R2 through the fixed carrier CR2. Thus, forward rotation as the first forward speed is output from the counter gear 11.

During engine braking (coasting), the above-described state of the first forward speed is maintained in the manner in which the brake B-2 is locked to fix the carrier CR2 so that the carrier CR2 is prevented from rotating forward.

Because the carrier CR2 is prevented from rotating in the reverse direction and allowed to rotate forward by the one-way clutch F-1 at the first forward speed, the first forward speed can be smoothly achieved by automatic engagement of the one-way clutch F-1, in the case, for example, of a shift from a non-drive range to a drive range.

In second forward speed (2ND), the clutch C-1 is engaged and the brake B-1 is locked, as shown in FIG. 3. Then, as shown in FIGS. 2 and 4, the rotation of the carrier CR1, which is rotated at a decelerated speed (“decelerated rotation”) by the ring gear R1 in cooperation with the fixed sun gear, is introduced to the sun gear S3 through the clutch C-1. In addition, the sun gear S2 is held stationary (without rotation) by the locking of the brake B-1. Then, the carrier CR2 rotates at a decelerated speed slower than that of the sun gear S3, and the decelerated rotation introduced to the sun gear S3 is output to the ring gear R2 through the carrier CR2. Thus, forward rotation as the second forward speed is output from the counter gear 11.

If the clutch C-1 is released from its state in the second forward speed (to a slipping state) by neutral control, the ring gear R2 is allowed to rotate forward and prevented from rotating in reverse by the one-way clutch F-1, thereby preventing the reverse rotation of the carrier CR2 and establishing the so-called hill holding, in which the reverse motion of a vehicle (reverse rotation of drive wheels) is prevented.

In third forward speed (3RD), the clutch C-1 and the clutch C-3 are engaged, as shown in FIG. 3. Then, as shown in FIGS. 2 and 4, the rotation of the carrier CR1, which is rotated at a decelerated speed (“decelerated rotation”) by the ring gear R1 in cooperation with the fixed sun gear, is introduced to the sun gear S3 through the clutch C-1. In addition, the decelerated rotation of the carrier CR1 is introduced to the sun gear S2 by the engagement of the clutch C-3. Because the decelerated rotation of the carrier CR1 is introduced to the sun gear S2 and the sun gear S3, the planetary gear unit PU rotates with the decelerated rotation in a directly connected state, and the decelerated rotation is directly output to the ring gear R2. Thus, forward rotation as the third forward speed is output from the counter gear 11.

In fourth forward speed (4TH), the clutch C-1 and the clutch C-2 are engaged, as shown in FIG. 3. Then, as shown in FIGS. 2 and 4, the rotation of the carrier CR1, which is rotated at a decelerated speed (“decelerated rotation”) by the ring gear R1 in cooperation with the fixed sun gear, is introduced to the sun gear S3 through the clutch C-1. In addition, the input rotation is introduced to the carrier CR2 by the engagement of the clutch C-2. A decelerated rotation faster than that of the third forward speed is produced by the combination of the decelerated rotation introduced to the sun gear S3 and the input rotation introduced to the carrier CR2, and is output to the ring gear R2. Thus, forward rotation as the fourth forward speed is output from the counter gear 11.

In fifth forward speed (5TH), the clutch C-2 and the clutch C-3 are engaged, as shown in FIG. 3. Then, as shown in FIGS. 2 and 4, the rotation of the carrier CR1, which is rotated at a decelerated speed (“decelerated rotation”) by the ring gear R1 in cooperation with the fixed sun gear, is introduced to the sun gear S2 through the clutch C-3. In addition, the input rotation is introduced to the carrier CR2 by the engagement of the clutch C-2. Thus, an accelerated rotation slightly faster than the input rotation is produced by the combination of the decelerated rotation introduced to the sun gear S2 and the input rotation introduced to the carrier CR2, and is output to the ring gear R2. Thus, forward rotation as the fifth forward speed is output from the counter gear 11.

In sixth forward speed (6TH), the clutch C-2 is engaged and the brake B-1 is locked, as shown in FIG. 3. Then, as shown in FIGS. 2 and 4, the input rotation is introduced to the carrier CR2 by the engagement of the clutch C-2. In addition, the sun gear S2 is held stationary (without rotation) by the locking of the brake B-1. The rotation of the carrier CR2 is accelerated to a speed faster than that of the fifth forward speed because sun gear S2 is fixed, is output to the ring gear R2. Thus, the forward rotation as the sixth forward speed is output from the counter gear 11.

In first reverse speed (REV), the clutch C-3 is engaged and the brake B-2 is locked, as shown in FIG. 3. Then, as shown in FIGS. 2 and 4, the rotation of the carrier CR1, which is rotated at a decelerated speed (“decelerated rotation”) by the ring gear R1 in cooperation with the fixed sun gear, is introduced to the sun gear S2 through the clutch C-3. In addition, the carrier CR2 is held stationary (without rotation) by the locking of the brake B-2. Then, the decelerated rotation introduced to the sun gear S2 is output to the ring gear R2 through the fixed carrier CR2. Thus, reverse rotation as the first reverse speed is output from the counter gear 11.

In the P (parking) range and in the N (neutral) range, the clutches C-1, C-2, and C-3 are disengaged to disconnect the carrier CR1 from the sun gears S2 and S3, that is, the planetary gear set SP and the planetary gear unit PU are disconnected, and also the input shaft 10 and the carrier CR2 are disconnected from each other. Consequently, there is no power transmission from the input shaft 10 to the planetary gear unit PU or to the counter gear 11.

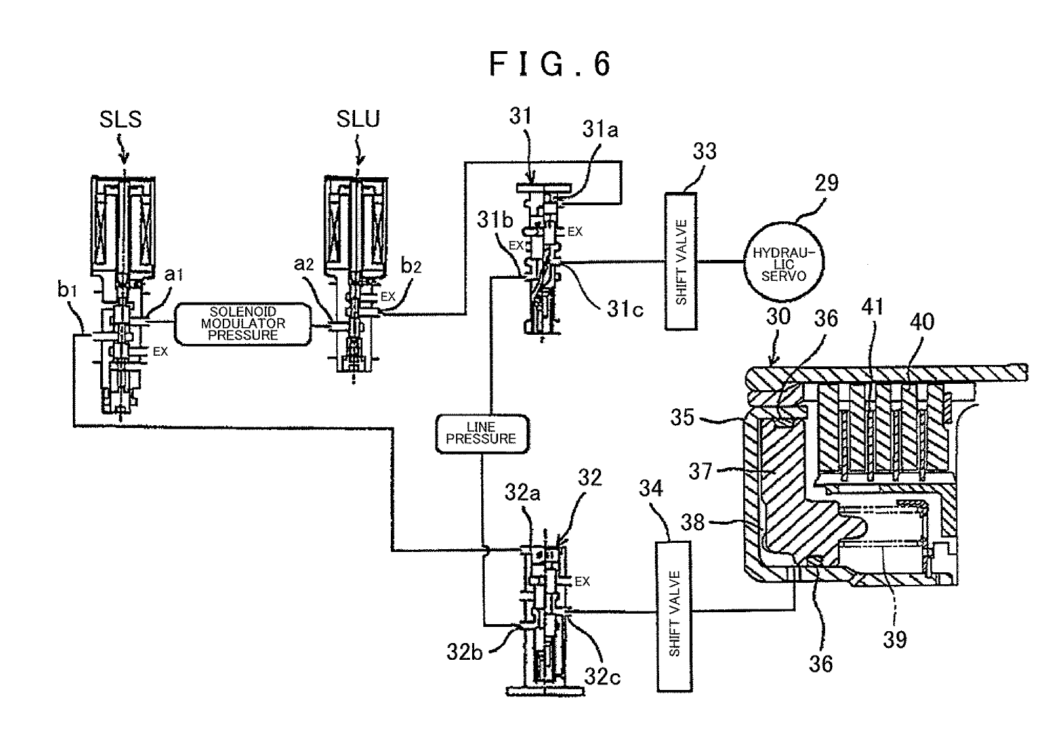

Next, the hydraulic circuit in the hydraulic control device 6 will be described with reference to FIG. 6. The hydraulic circuit has two linear solenoid valves SLS and SLU, and also has a plurality of hydraulic servos 29 and 30 that disconnect and connect the plurality of friction engagement elements for selectively establishing, for example, six forward speeds and one reverse speed by switching the transmission path through the planetary gear unit in the automatic speed change mechanism. A solenoid modulator pressure is supplied to input ports a₁ and a₂ of the linear solenoid valves SLS and SLU, respectively, and control hydraulic pressures from output ports b₁ and b₂ of the corresponding linear solenoid valves are supplied to control fluid chambers 31a and 32a of corresponding pressure control valves 31 and 32, respectively. The pressure control valves 31 and 32 are supplied with a line pressure through input ports 31b and 32b, respectively, and regulated pressures that are regulated by the control hydraulic pressures are supplied from output ports 31c and 32c through shift valves 33 and 34 to the hydraulic servos 29 and 30, respectively, as appropriate.

Note that the hydraulic servos 29, 30 and the shift valves 33, 34 are shown as merely representative of the larger number of hydraulic servos provided for operation of the automatic speed change mechanism 5, and the larger number of shift valves provided for switching hydraulic pressures to the hydraulic servos. As shown for the hydraulic servo 30, the hydraulic servo has a piston 37 that is fit in a cylinder 35 in an oil-tight manner with oil seals 36. Responsive to the regulated hydraulic pressure from the pressure control valve 32 that acts in hydraulic pressure chamber 38, the piston 37 moves against a return spring 39 to bring the outer friction plates 40 into contact with the inner friction materials 41. Although the friction plates and the friction materials are shown as a clutch, it is obvious that the engagement element so controlled could instead be a brake.

As shown in FIG. 1, the shift control apparatus 1 for the automatic transmission is provided with the control unit (ECU) 12 that receives a signal from the engine (E/G) 2, signals from an input shaft rotational speed sensor 22 and an output shaft rotational speed (vehicle speed) sensor 23 of the automatic transmission 3 (automatic speed change mechanism 5), a signal from the strain gauges 24, and a signal from an accelerator opening sensor 25. The input shaft rotational speed sensor 22 detects the rotational speed of the transmission input shaft 10, and the output shaft rotational speed sensor 23 detects the rotational speed of the transmission output shaft (not shown) provided on the downstream side of the counter gear 11.

The control unit 12 includes a torque control unit 14 having a torque reduction command unit (“torque change command unit” or “torque down command unit”) 13, an inertia phase detecting unit 15, a torque value calculating unit 16, an input equivalent value calculating unit 42, a shift control unit 17, a shift map 18, a torque change determination unit 43, an engine speed detecting unit 19, and a learning control unit 28. Note that the torque value calculating unit 16 and the strain gauges 24 in combination serve as a fixed gear torque detecting unit that detects a value for torque acting on the sun gear S1 based on a reaction force.

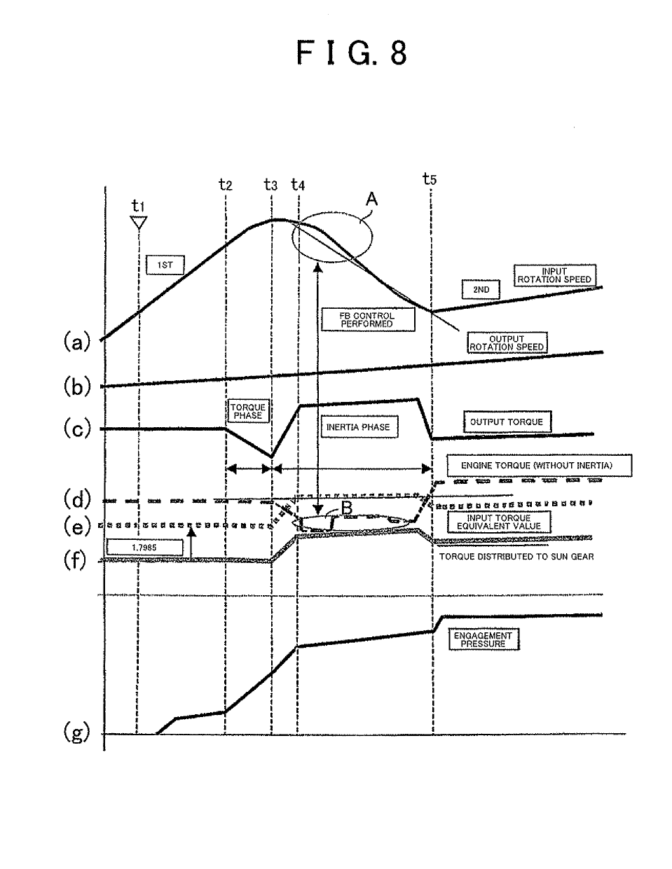

The torque reduction command unit 13 issues a command to the engine 2 for a torque reduction (“torque change” or “torque down”) in an inertia phase. The command mentioned above is issued when the start of the inertia phase (substantially at time t₃ in FIG. 8) has been detected by the inertia phase detecting unit 15. That is, at the time when the start of the inertia phase has been detected by the inertia phase detecting unit 15, the torque reduction command unit 13 issues the above-mentioned command to the engine 2 for performing the torque reduction so as to reduce a shift shock (that is, to reduce the inertia torque of the engine 2 acting on the clutches and the brakes while shifting). Specifically, by issuing the torque reduction command to the engine 2 in the inertia phase during shifting, the engine torque is reduced so as to suppress the increase of engine speed and also to reduce the generation of the engine inertia torque. In addition, the torque control unit 14 provides torque control in addition to the torque reduction performed by the torque reduction command unit 13.

The torque value calculating unit 16 calculates the value for torque acting on the sun gear S1 based on the strain detected by the strain gauges 24. That is, the torque value calculating unit 16 is electrically connected to the strain gauges 24 so as to apply an electrical signal to the strain gauges 24 and to receive an electrical signal from the strain gauges 24 indicative of the strain on the sun gear S1. Then, the torque value calculating unit 16 calculates the value for torque acting on the sun gear S1 based on the strain detection by the strain gauges 24. More specifically, the torque value calculating unit 16 has an amplifier (not shown) for amplifying the output signal from the strain gauges 24, and calculates (detects) the value for torque acting on the sun gear S1 based on the output voltage of the strain gauges 24 that has been amplified by the amplifier.

The inertia phase detecting unit 15 detects the start point of the inertia phase (substantially at the time t₃ in FIG. 8) at which a rotation change starts in the automatic speed change mechanism 5, based on a change in the torque value detected by the strain gauges 24 and the torque value calculating unit 16. That is, the inertia phase detecting unit 15 detects the start of the inertia phase at which the rotation change starts in the automatic speed change mechanism 5, based on the torque value calculated by the torque value calculating unit 16. The inertia phase detecting unit 15 has a preset threshold value, judges whether or not the torque value calculated by the torque value calculating unit 16 has exceeded the threshold value, and determines that the inertia phase has started when the torque value has exceeded the threshold value. A torque value sufficient to be distinguishable from disturbances at the time t₃ in FIG. 8 is set as the threshold value.

The input equivalent value calculating unit 42 calculates an input torque equivalent value based on the torque value detected by the strain gauges 24 and the torque value calculating unit 16. That is, the input equivalent value calculating unit 42 calculates the input torque (refer to (e) in FIG. 8) by multiplying the torque distributed to (transmitted) the sun gear (refer to (f) in FIG. 8) by, for example, 1.7985 at a shift speed between the first speed (1ST) and the third speed (3RD), by multiplying the torque distributed to the sun gear by, for example, 6.25 at the fourth speed (4TH), or by multiplying the torque distributed to the sun gear by, for example, −6.76 at the fifth speed (5TH). However, at the sixth speed (6TH), it is impossible to calculate the input torque equivalent value (0) based on the torque value because the rotation of the input shaft 10 is transmitted to the counter gear 11 only through the planetary gear unit PU without passing through the planetary gear set SP.

The shift control unit 17 issues electrical commands to solenoid valves (not shown) provided in the hydraulic control device 6 to control the hydraulic pressure supplied to the corresponding hydraulic servos for the clutches C-1, C-2, and C-3, and the brakes B-1 and B-2 that serve as friction engagement elements, thereby shifting speeds by switching engagement among those clutches and brakes. More specifically, in the case of power-on upshift, the shift control unit 17 refers to the shift map 18, applying a vehicle speed that is calculated from, for example, the rotational speed of the output shaft (not shown) of the automatic speed change mechanism 5 detected by the output shaft rotational speed sensor 23, and also based on the accelerator opening detected by the accelerator opening sensor 25. If the accelerator opening has at least a predetermined opening and if an upshift point is judged, the shift control unit 17 issues commands to the solenoid valves (not shown) in the hydraulic control device 6 to switch engagement among the friction engagement elements in the automatic speed change mechanism 5, thereby performing the power-on upshift. The shift control unit 17 provides the shift control as described above by controlling the hydraulic pressure supplied to each of the hydraulic servos so that the hydraulic pressure changes with a predetermined sweep gradient (refer to (g) in FIG. 8), based on the input torque equivalent value (refer to (e) in FIG. 8) obtained based on the torque value detected by the combination of the strain gauges 24 and the torque value calculating unit 16.

The torque change determination unit 43 determines whether or not the torque of the engine 2 has actually been appropriately reduced in accordance with the command of the torque reduction command unit 13, based on the input torque equivalent value (refer to (e) in FIG. 8) calculated by the input equivalent value calculating unit 42. For example, if the torque reduction command unit 13 has issued a command to reduce the torque, by 30 [Nm], it is determined that the torque has been appropriately reduced if the input torque equivalent value is within an allowable range (for example, ±[Nm]) set in advance (predetermined).

Signals including an engine torque signal are sent from the engine 2 to the control unit 12, and based on the signals from the engine 2, the engine speed detecting unit 19 detects the rotational speed of the engine 2 (hereinafter called “engine speed”).

The present embodiment, by checking the peak torque, the rotational speed acceleration, and time for shifting during the inertia phase, can identify, as the cause of error in the current shift control, either the amount of the torque reduction or the engaging-side hydraulic pressure, and an optimal amount of modification (amount of correction) can be calculated. More specifically, the learning control unit 28 performs learning in the shifting, based on the engagement state of the friction engagement elements set by the shift control unit 17 and based on the amount of engine torque (driving source torque) resulting from the engine torque reduction caused by the torque reduction command unit 13.

More specifically, the learning control unit 28 can learn the state of engagement of, for example, the brake B-1 (“first engagement element” in the case of a 1st-to-2nd shift) caused by the shift control unit 17. In the case that the torque change determination unit 43 has determined that the torque change of the engine 2 has not been appropriate (correct), the learning control unit 28 does not apply the learning correction to the next shift control cycle. On the other hand, if the torque change determination unit 43 determines that the torque change of the engine 2 has been appropriately performed, the learning control unit 28 applies the learning correction to the learning value (command value) in the next shift control cycle.

Thus, if in the current shift control, the rotational speed acceleration change is larger than appropriate, although the input torque equivalent value is appropriate, learning correction determined from the current shift is not applied to the next shift, because the torque reduction caused by the torque reduction command unit 13 is excessive. In the case that the input torque equivalent value is larger than expected, although there is no problem in the amount of the torque reduction, the learning correction determined from the current shift is applied to the learning value to be used in the next shift, based on the judgment that the engaging-side hydraulic pressure has been excessively increased by the shift control unit 17.

If the hydraulic pressure is increased by the shift control unit 17 to a level at which the input torque equivalent value at an initial stage of shifting exceeds a certain (predetermined) value, the learning control unit 28 learns the hydraulic pressure at which the input torque equivalent value at the initial stage of shifting has exceeded that certain value, and executes the learning correction for the next shift control by using, as a learning value, the hydraulic pressure command value calculated so that the input torque equivalent value during shifting falls within a certain range (for example, within ±15%).

In addition, the learning control unit 28 compares the mean value of the input torque equivalent value with the planned (target) input torque equivalent value (hereinafter “comparison A”), and compares the actual time for shifting with the planned (target) time for shifting (hereinafter “comparison B”). Then, based on the results of the comparisons A and B, the learning control unit 28 executes learning for both the hydraulic pressure and the amount of engine torque reduction, thus executing cooperative learning control so that the shift shock in the next shift control is as favorable as possible.

For example, in a conventional shift control wherein the engagement start time and the piston stroke state are satisfactory: the hydraulic pressure is reduced if the difference determined in comparison B has been small (that is, the time for shifting has been short); the hydraulic pressure is left unchanged if the result of the comparison B has indicated that the shift was at the appropriate time; and the hydraulic pressure is increased if the difference determined in comparison B is large (that is, the time for shifting has been long).

In contrast, in the shift control according to the present invention (where, the engagement start time and the piston stroke state are appropriate (satisfactory), and the difference determined in the comparison A is within the satisfactory range), the torque reduction is reduced if the difference determined in the comparison B is small (that is, the time for shifting is short); the torque reduction is left unchanged if the result of the comparison B has indicated that the shift was at the appropriate time; and the torque reduction is increased if the difference determined in comparison B is large (that is, the time for shifting is long). In addition, in the shift control of the present invention when the engagement start time and the piston stroke state are satisfactory and the result of the comparison B is satisfactory, the hydraulic pressure is increased if the result of the comparison A is small (that is, the shift shock is excessively reduced); the hydraulic pressure is left unchanged if the result of the comparison A indicates appropriate shift shock; and the hydraulic pressure is reduced if the difference determined by comparison A is large (that is, the shift shock is excessive).

Then, in the learning control unit 28 an overall judgment is calculated as described below. That is, the amount of correction based on the comparison A is expressed in terms of torque (TA: amount of correction on hydraulic pressure side), and the amount of correction based on the comparison B is also expressed in terms of torque (TB: amount of correction on engine torque side). If both TA and TB are modified at the same time, the learning will not give the expected timing for shifting in the next shift control, because the controls for TA and TB will overlap each other.

For example, in the case that the amount of correction TA is set to ±20 [Nm] because the shift shock is excessively reduced (too favorable), and at the same time, the amount of correction TB is set to −30 [Nm] because it is determined that the time required for shifting is too long, if the hydraulic pressure is increased so that 20 [Nm] is added to the engagement torque, the time for shifting in the next shift control is reduced by an amount corresponding to 20 [Nm]. Therefore, unless the actual amount of correction on the engine torque side in the next shift control is set as −30 [Nm]+20 [Nm]=−10 [Nm], the time for shifting becomes shorter than expected. That is, by giving a higher priority to the engagement torque side (amount of correction on the hydraulic pressure side), the engagement pressure is calculated from the amount of correction TA in the learning, and the correction value is given as TB−TA for the amount of torque reduction of the engine 2. Alternatively, the engagement pressure can be calculated from the amount of correction TB for the amount of modification of learning, and the correction value can be given as TA−TB for the amount of modification on the hydraulic pressure side.

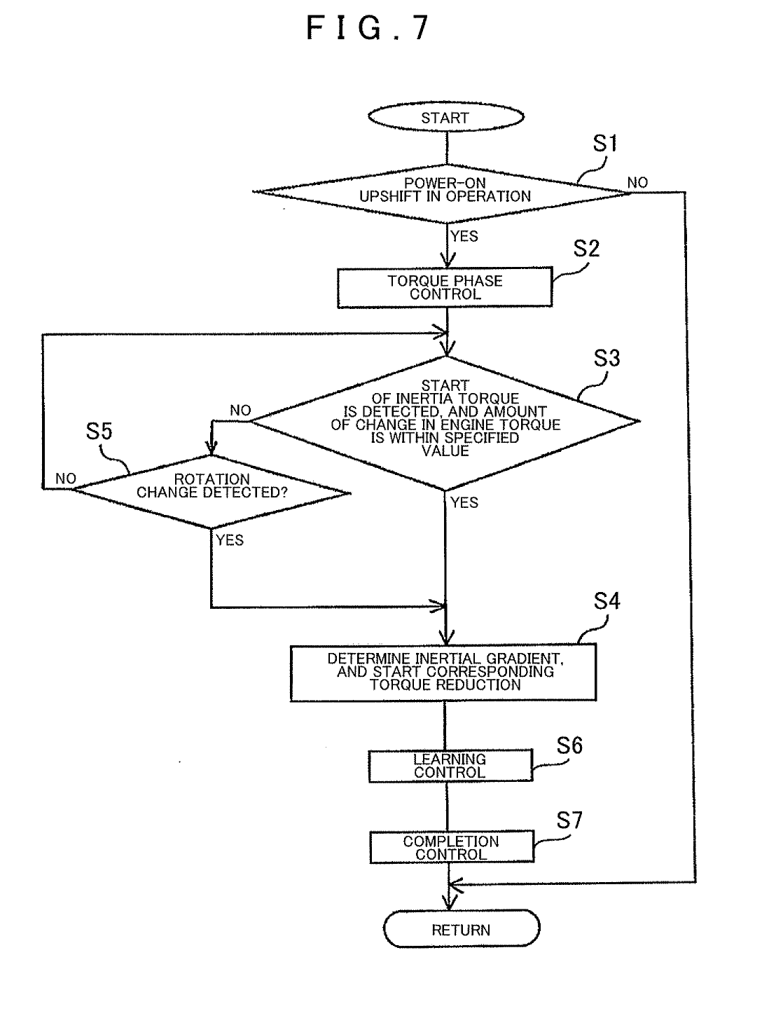

Next, the control by the shift control apparatus I for the automatic transmission will be described with reference to FIG. 1, the flow chart in FIG. 7, and the time chart in FIG. 8.

Note that, in FIG. 8, (a) shows the change in the input rotational speed of the input shaft 10 of the automatic speed change mechanism 5; (b) shows the change in output rotational speed of the output shaft (not shown) on the downstream side of the counter gear 11; (c) shows the output torque of the output shaft; (d) shows the change in the engine torque equivalent value (without inertia); (e) shows the change in the input torque equivalent value that the input equivalent value calculating unit 42 has calculated by multiplying by 1.7985 the torque distributed to the sun gear shown by (f); (f) shows the change in the torque distributed to the sun gear S1; and, (g) shows the change in the engagement pressure to a hydraulic servo corresponding to, for example, the brake B-1 to be engaged.

The control by the shift control apparatus 1 starts, for example, when the ignition switch (not shown) is turned on and the engine 2 is powered on, and waits (stand-by) until the shift control unit 17 detects that a power-on upshift has been initiated in the automatic speed change mechanism 5. Then, while the vehicle is running under control of operation of the accelerator pedal by the driver, for example in first speed, the shift control unit 17 refers to the shift map 18 based on the vehicle speed calculated from the rotational speed of the output shaft of the automatic speed change mechanism 5 detected by the output shaft rotational speed sensor 23, and also based on the accelerator opening detected by the accelerator opening sensor 25. If the accelerator opening is at least the predetermined opening and if the upshift point is judged (step S1: YES), the shift control unit 17 commands the power-on upshift, for example, from 1st to 2nd speed.

More specifically, at time t₁ shown in FIG. 8, that is after a predetermined time has passed from the time when the accelerator opening has been increased by the driver's pressing down on the accelerator pedal to cross over the shift point from the first speed region to the second speed region in the shift map 18, the shift control unit 17 judges need for a 1st-to-2nd shift. Then, a shift command (flag) is set to the second speed in the shift control unit 17 from the time t₁, and 1st-to-2nd shift control is started.

Then, after a predetermined time for preprocessing, such as operation of a predetermined shift valve operation, has passed, the shift control is started to control engaging-side hydraulic pressure and disengaging-side hydraulic pressure. Note that in the shift control, the driver holds the operation of the accelerator pedal at a substantially constant level, and during the shift, the upshift control is performed in the power-on state in which power is transmitted from the engine to the drive wheels.

In the 1st-to-2nd shift control, as will be described later, after the engaging-side hydraulic pressure has been increased once and a backlash reduction operation has been performed on the hydraulic servo of the brake B-1, the brake B-1 is gradually engaged, and along with this the one-way clutch F-1 is gradually released (disengaged) because the rotation is reversed.

The shift control unit 17 starts torque phase control in accordance with lapse of time or detection of rotational change (S2). In the torque phase control, the torque supported by the brake B-1 on the engaging side increases, and thus, only the torque distribution changes while the gear ratio stays at the level before the upshift (first speed).

Subsequently, (initial control) the shift control unit 17 issues electronic control commands to the hydraulic control device 6, and inertia phase control in which the automatic speed change mechanism 5 actually shifts is started. Then, the input rotational speed is increased in response to the increase in the engine speed along with the slip of the brake B-1. Thus, the automatic speed change mechanism 5 gradually shifts to the second speed, that is, the shift progress ratio gradually increases. After the engagement pressure of the brake B-1 has been increased once and backlash reduction has been performed on its hydraulic servo (not shown), the brake B-1 is gradually engaged to start the torque phase at time t₂, and along with this, the engagement of the one-way clutch F-1 is released. As a result, the output torque of the automatic speed change mechanism 5 is gradually reduced from the time t₂ to time t₃, transferring the torque distribution toward the brake B-1.

Immediately after time t₃, the inertia phase detecting unit 15 accurately detects the starting point of the inertia phase at which the rotational change starts in the automatic speed change mechanism 5, based on the torque value calculated by the torque value calculating unit 16. That is, when the change in the torque value detected by the torque value calculating unit 16 and the strain gauges 24 has exceeded the threshold value, the inertia phase detecting unit 15 detects that point in time as the starting point of the inertia phase (slightly after the time t₃).

Referring to FIG. 2, in first speed the rotation of the input shaft 10 is transmitted from the ring gear R1 through the pinion P1 to the carrier CR1 that receives the reaction force of the sun gear S1, then transmitted from the carrier CR1 through the clutch C-1 to the sun gear S3, further transmitted to the ring gear R2 through the short pinion PS and the long pinion PL that are supported by the carrier CR2 locked by the one-way clutch F-1, and finally transmitted from the ring gear R2 through the counter gear 11 to the output shaft. In this state, when the torque has been transferred to the brake B-1 and the inertia phase has been started, the rotation of the input shaft 10 is transmitted from the ring gear R1 to the carrier CR1 in the same manner as described above. Then, with the sun gear S2 locked by engagement of the brake B-1 and the carrier CR2 disengaged from the one-way clutch F-1, the rotation is transmitted from the carrier CR1 to the ring gear R1 through the sun gear S3, the short pinion PS, and the long pinion PL, and finally transmitted from the ring gear R2 through the counter gear 11 to the output shaft. At this time, because the sun gear S1 that receives the reaction force from the pinion P1 generates strain in its shaft portion 26, the strain is detected by the strain gauges 24.

Thus, the torque value calculating unit 16 receives the electrical signal that is output from the strain gauges 24 due to the strain of the sun gear S1, and calculates the value for torque acting on the sun gear S1. Then, the inertia phase detecting unit 15 compares the torque value calculated by the torque value calculating unit 16 with the threshold value, and determines that the inertia phase has started when the torque value has exceeded the threshold value. Then, in the state in which the start of inertia torque (that is, the start of inertia phase) is detected, the torque control unit 14 simultaneously judges whether or not the engine torque is less than a predetermined (specified) value (because the shift becomes a shift jump, such as 1st-2nd-3rd shift, if the predetermined value is exceeded).

As a result, if the start of inertia torque is detected and the amount of change in the engine torque is judged to be less than the specified value (S3: YES), the process proceeds to step S4, in which an inertial gradient (that is, the sweep-up gradient of the engagement pressure (g) in FIG. 8) is determined (the hydraulic pressure is increased until a target input torque is obtained), and the torque reduction corresponding to the gradient is started by the command of the torque reduction command unit 13. Thus, the engine torque is reduced from time t₄ on (d) in FIG. 8, and the output torque is reduced in the inertia phase as shown by (c) in FIG. 8, thus avoiding generation of a large inertia torque in the engine 2 and therefore effectively suppressing shift shock.

On the other hand, if the torque cannot be detected by the strain gauges 24 in step S3, such as in the case of shifting from the fifth speed to the sixth speed, the process proceeds to step S5 in which the inertia phase is judged by detecting the rotational change in a known manner, and then the process proceeds to step S4 in which the torque reduction is started.

Subsequently, the shift control unit 17 increases the hydraulic pressure of the brake B-1 to further engage the brake B-1 under feedback control in accordance with the shift progress ratio. Then, as time t₅ is near the time at which the inertia phase is finished, the shift control unit 17 proceeds to final control in which the hydraulic pressure of the brake B-1 is rapidly increased, and then further increased to make the engagement of the brake B-1 complete by, for example, switching the circuit for the hydraulic pressure to the hydraulic servo of the brake B-1 so as to directly introduce the line pressure. Thus, the 1st-to-2nd shift control is completed. Note that the learning of the initial hydraulic pressure and the level in the inertia phase can also be adjusted by feedback control (FB control) as indicated by the time lines for (b) and (c) within circle A in FIG. 8).

Then, in step S6, the learning control is performed by the learning control unit 28. Here, if the torque change determination unit 43 has determined that the torque change of the engine 2 has been appropriately completed, the learning control unit 28 applies the learning correction to the learning value of the current (present) shift cycle and executes the next shift control so as to reflect that corrected learning value. On the other hand, if the torque change determination unit 43 has determined that the torque change of the engine 2 has not been appropriately completed, the learning control unit 28 does not apply the learning correction to the learning value in the current (present) shift control and maintains that the learning value (without learning correction) in the next shift control.

Next, completion control is performed in step S7. That is, in the completion control, a time equal to the remaining time of the completion control for the disengaging-side hydraulic pressure control is set in the timer, and the engaging-side hydraulic pressure is swept up at a predetermined gradient set in advance. The sweep-up is continued until the predetermined time set above has elapsed, and the completion control finishes when the set time has elapsed. Thus, the 1st-to-2nd shift is completed.

In the present embodiment described above, the strain gauges 24 and the torque value calculating unit 16 detect the torque value acting on the sun gear S1 based on the reaction force, the input equivalent value calculating unit 42 calculates the input torque equivalent value based on the detected torque value, the torque reduction command unit 13 issues to the engine 2 the command for changing torque, and based on the calculated input torque equivalent value, the torque change determination unit 43 determines whether or not the torque of the engine 2 has been appropriately changed in accordance with the command. Consequently, based on the torque value measured for the sun gear S1 that is a component of the automatic speed change mechanism 5, it can be precisely determined whether or not the torque change of the engine 2 has been appropriately achieved as targeted. For example, when the engaging-side hydraulic pressure for the engagement element such as the brake B-1 has been increased and then the engaging side starts to receive torque, the inertia change on the input side enables detection of the input torque by using the strain gauges 24 and the torque value calculating unit 16. By using the input torque equivalent value as an indicator for control during shifting, it can be immediately determined whether there has been a problem in the amount of the torque reduction if the rotational speed change (acceleration) is not as expected, and if there has not been a problem in the amount of the torque reduction, it can then be immediately judged that there has been a problem in the engaging-side hydraulic pressure.

Also in the present embodiment, if it is determined that the torque of the engine 2 has not been appropriately changed, the learning control unit 28, that is capable of learning the engagement state of the brake B-1 and so forth caused by the shift control unit 17, refrains from applying a learning correction to the learning value to be used in the next shift control. In the prior art, shift control has been mainly by controlling the engagement side hydraulic pressure. However, in the present invention, it is determined whether or not the torque change has been appropriately achieved as targeted, and if the torque reduction has been inaccurate because the spark retard has not been effected or has been excessive, the current learning value is left unchanged in the next shift control cycle.

In addition, according to the present embodiment, the inertia phase detecting unit 15 detects, based on the change in the torque value detected by the strain gauges 24 and the torque value calculating unit 16, the start of the inertia phase at which the rotation change starts in the automatic speed change mechanism 5, and the torque reduction command unit 13 issues the command for torque reduction when the start of the inertia phase has been detected. Therefore, by detecting the change in the torque value acting on the sun gear S1, it is possible to detect the start of the inertia phase quickly and accurately, thereby enabling the torque change to be performed at an appropriate timing.

Also, in the present embodiment, the fixed gear torque detecting unit is composed of the strain gauges 24 that detect the strain between the sun gear S1 and the transmission case 9 caused by the torque acting from the input shaft 10, and the torque value calculating unit 16 that calculates the value for torque acting on the sun gear S1, based on the output from the strain gauges 24. Consequently, the strain gauge 24, which has a simple structure and comparatively low cost, can be used as a strain detecting sensor, and because a structure for easily detecting the strain between the sun gear S1 and the transmission case 9 is obtained simply by directly mounting the strain gauge 24 on he sun gear S1, it is possible to detect, with an extremely simple structure, the torque value used for detecting the inertia phase that serves as a trigger to start the torque reduction.

In the case of judging the above-described start of the inertia phase from the start of change in the input shaft rotational speed, the start of the inertia phase may be erroneously judged due to a disturbance. In order to prevent such an erroneous judgment, in one method, a predetermined difference is compared with the difference in change in rotational speed when the rotation changes or with the amount of change in rotational acceleration. In this method, the judgment of the start of the inertia phase is delayed because the inertia phase is not judged as started until the predetermined difference is obtained. Therefore, there has been a problem in that the start of the torque reduction is also delayed. However, the problem is solved by the present invention in which the fixed gear torque detecting unit detects as accurately as possible the torque, which, in turn, is value used for detecting the inertia phase.

Moreover, in the present embodiment, the automatic speed change mechanism 5 includes the planetary gear set SP for outputting decelerated rotation at a speed that is decelerated from the rotational speed of the input shaft 10, the planetary gear unit PU that has the four rotary elements (S2, S3, CR2, and R2) including the ring gear R2 connected to the output shaft (not shown) of the automatic speed change mechanism 5, the two clutches C-1 and C-3 that engage to transmit rotation of the planetary gear set SP to the two respective (S3 and S2) rotary elements of the planetary gear unit PU, and the clutch C-2 that, when engaged, transmits rotation of the input shaft 10 to the one rotary element (carrier CR2) of the planetary gear unit PU, thereby achieving the six forward speeds.

In this embodiment, the sun gear S1 is the gear that is constantly held stationary (without rotation) in the planetary gear set SP. Therefore, by using a comparatively simple structure in which merely the strain detecting sensor or the like is attached to the sun gear S1 when assembling the automatic speed change mechanism 5, the inertia phase can be detected early and accurately for use in shift control, and the result of detection can be used for preventing erroneous learning in the learning control. Note that the present invention can be applied, not only to a six forward speed automatic transmission, but also to automatic transmissions providing less or more forward speeds.

As described above, the planetary gear set SP is composed of the sun gear S1 that is fixed to the transmission case 9, the ring gear R1 that outputs the decelerated rotation, and the carrier CR1 that receives the rotation of the input shaft 10, where the sun gear S1 serves as a fixed gear. Therefore, in the automatic speed change mechanism 5 including the gear train that has the sun gear S1 fixed to the transmission case 9, by using a comparatively simple structure in which merely the strain gauges 24 are attached to the sun gear S1, the input torque can be detected early and accurately, and used for learning control.

In the embodiment described above, the learning control unit 28 performs the learning control so as to apply a learning correction to the engaging-side hydraulic pressure. However, the present invention is not so limited, and a learning correction may instead be applied to the engine torque after torque reduction. In such an embodiment, if the amount of torque reduction has been reduced, for example, from 100 [Nm] to 50 [Nm] by a command from the torque reduction command unit 13, the learning control unit 28 applies the learning correction to this value (learning value) to obtain a new, corrected, command value for use in the next shift control.

Also, the embodiment has been described above as control during a 1st-to-2nd shift. However, the present invention may also be applied to control of a 2nd-to-3rd shift, a 3rd-to-4th shift, and/or a 4th-to-5th shift. In addition, the foregoing embodiment has been described as applied to an automatic transmission suitable for use in an FF type vehicle, that achieves six forward speeds and one reverse speed. However, the present invention is not limited to such an application, and can also be applied to an automatic transmission suitable for use in a FR (front engine, rear drive) type vehicle or any other type vehicle, if the automatic transmission is provided with a planetary gear set that has a gear (for example, a sun gear) constantly fixed to the transmission case.

Moreover, the embodiment described above has been explained with reference to a power-on upshift. However, the present invention can also be applied in the same manner to a power-on downshift, although the torque in the inertia phase is generated in the negative direction. Furthermore, the present invention can also be applied to a torque up of the engine 2 in the torque phase so that the torque up cancels out the shift shock generated by the torque reduction in the torque phase, i.e. shift shock due to the torque increase that occurs during the inertia phase can be appropriately suppressed by the torque reduction that starts at the time of detection of the inertia phase.

Note that in the embodiment described above, torque reduction has been given as an example of “torque down”. However, the present invention may instead perform torque limitation as a torque down.

The shift control apparatus for an automatic transmission according to the present invention can be used in an automatic transmission mounted on a passenger vehicle, truck, bus, agricultural machine, or the like, and is particularly suitable for use in an automatic transmission wherein determination of whether or not a torque change for a driving source such as an engine is appropriate.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed is:

1. A shift control apparatus for an automatic transmission in a vehicle, comprising:
a stepped speed change mechanism that receives rotation of a driving source at an input shaft and couples an output member to drive wheels, the speed change mechanism including a fixed gear that is fixed to a transmission case and generates a reaction force against the rotation of the input shaft;
a plurality of engagement elements, including first and second engagement elements, that are selectively engaged and disengaged to change power transmission paths between the input shaft and the output member;
hydraulic servos that engage and disengage the engagement elements;
a shift control unit controls operation of the hydraulic servos so as to engage the first engagement element and disengage the second engagement element to perform a shift to a predetermined shift speed;
a fixed gear torque detecting unit that detects, based on the reaction force, a torque value for torque acting on the fixed gear;
an input equivalent value calculating unit that calculates an input torque equivalent value based on the detected torque value;
a torque change command unit that issues a command for changing torque to the driving source; and
a torque change determination unit that determines, based on the calculated input torque equivalent value, whether or not the torque of the driving source has been appropriately changed in accordance with the command of the torque change command unit.

2. The shift control apparatus for an automatic transmission according to claim 1, further comprising:
a learning control unit that learns an engagement state of the first engagement element caused by the shift control unit, wherein
the learning control unit refrains from making a learning correction if the torque change determination unit determines that the torque of the driving source has not been appropriately changed.

3. The shift control apparatus for an automatic transmission according to claim 2, further comprising:
an inertia phase detecting unit that detects a start of an inertia phase, based on a change in the torque value detected by the fixed gear torque detecting unit, wherein
the torque change command unit is a torque down command unit that issues a command for a torque down as the torque change when the start of the inertia phase has been detected by the inertia phase detecting unit.

4. The shift control apparatus for an automatic transmission according to claim 3, wherein:
the fixed gear torque detecting unit is composed of:
a strain detecting sensor that detects strain between the fixed gear and the transmission case caused by the torque acting from the input shaft side; and
a torque value calculating unit that calculates the torque value for the torque acting on the fixed gear, based on the strain detected by the strain detecting sensor.

5. The shift control apparatus for an automatic transmission according to claim 4, wherein:
the speed change mechanism includes:
a decelerating planetary gear set that outputs decelerated rotation at a speed that is decelerated from the rotational speed of the input shaft;
a planetary gear unit that has four rotary elements including an output element connected to an output shaft of the speed change mechanism;
two decelerating clutches that, when engaged, transmit rotation of the decelerating planetary gear set, respectively to two of the rotary elements of the planetary gear unit; and
an input clutch that, when engaged, transmits rotation of the input shaft to one of the rotary elements of the planetary gear unit, thereby achieving five or six forward speeds, and
wherein the fixed gear is a gear that is constantly held without rotation in the decelerating planetary gear set.

6. The shift control apparatus for an automatic transmission according to claim 5, wherein:
the decelerating planetary gear set is composed of a sun gear that is fixed to the transmission case, a ring gear that outputs the decelerated rotation, and a carrier that receives the rotation of the input shaft, and
the fixed gear is the sun gear.

7. The shift control apparatus for an automatic transmission according to claim 1, further comprising:
an inertia phase detecting unit that detects a start of an inertia phase, based on a change in the torque value detected by the fixed gear torque detecting unit, wherein
the torque change command unit is a torque down command unit that issues a command for performing a torque down as the torque change when the start of the inertia phase has been detected by the inertia phase detecting unit.

8. The shift control apparatus for an automatic transmission according to claim 1, wherein:
the fixed gear torque detecting unit is composed of:
a strain detecting sensor that detects strain between the fixed gear and the transmission case caused by the torque acting from the input shaft side; and
a torque value calculating unit that calculates the torque value for torque acting on the fixed gear, based on the strain detected by the strain detecting sensor.

9. The shift control apparatus for an automatic transmission according to claim 1, wherein
the speed change mechanism includes:
a decelerating planetary gear set that outputs decelerated rotation at a speed that is decelerated from the rotational speed of the input shaft;
a planetary gear unit that has four rotary elements including an output element connected to an output shaft of the speed change mechanism;
two decelerating clutches that, when engaged, transmit rotation of the decelerating planetary gear set respectively to two of the rotary elements of the planetary gear unit; and
an input clutch that, when engaged, transmits rotation of the input shaft to one of the rotary elements of the planetary gear unit, thereby achieving five or six forward speeds, and
wherein the fixed gear is a gear that is constantly held without rotation in the decelerating planetary gear set.
